(19) United States
(12) Patent Application Publication
(10) Pub. No.: US 2014/0222463 A1
(43) Pub. Date: Aug. 7, 2014

(54) ENHANCED MONITORING

(71) Applicant: Abbott Cardiovascular Systems Inc., Santa Clara, CA (US)

(72) Inventors: Billye Guthrie, JR., Santa Clara, CA (US); John W. Creech, Santa Clara, CA (US); Leslie Ornelas, Santa Clara, CA (US); Dana Haudek, Santa Clara, CA (US); Christopher Lewis, Santa Clara, CA (US)

(21) Appl. No.: 14/169,251

(22) Filed: Jan. 31, 2014

Related U.S. Application Data
(60) Provisional application No. 61/759,148, filed on Jan. 31, 2013.

(51) Int. Cl. G06F 19/00

(52) U.S. Cl. CPC G06F 19/363
USPC 705/3

(57) ABSTRACT

The presently disclosed subject matter provides for efficient and effective monitoring, while eliminating practices that may not be of value in assuring human subjects protection and reliable and informative study results. The present disclosure provides methods, computer program products, and systems for data collection and validation for Enhanced Monitoring (EM). The Enhanced Monitoring model disclosed herein increases productivity and efficiency by decreasing the frequency of on-site monitoring visits and employing remote review techniques to focus on the process as compared to individual data points.

### CROSS-REFERENCE TO RELATED APPLICATIONS

This application claims the benefit of U.S. Provisional Application No. 61/759,148, filed Jan. 31, 2013, which is hereby incorporated by reference in its entirety.

### BACKGROUND OF THE DISCLOSED SUBJECT MATTER

1. Field of the Disclosed Subject Matter

The disclosed subject matter relates to a system for enhanced monitoring of data during a variety of medical investigations and/or procedures. Particularly, the present disclosed subject matter is directed to risk-based monitoring during clinical trials.

The presently disclosed subject matter provides for efficient and effective monitoring, while eliminating practices that may not be of value in assuring human subjects protection and reliable and informative study results. The enhanced monitoring model disclosed herein increases productivity and efficiency by decreasing the frequency of on-site monitoring visits and employing remote review techniques to focus on the medical process as compared to individual data points.

2. Description of Related Art

Conventional clinical study monitoring needs to evolve to keep pace with the changing landscape which includes: increased complexity of studies; increased complexity of regulations; rapid advancement of medical technology (e.g. Electronic Data Capture (EDC), Electronic Medical Records (EMR), Electronic Health Records (EHR), etc.); increased demand on resources; and increased scrutiny by media and regulators.

Several regulatory aids and guidelines are available to practitioners, which include:
Clinical Trials Transformation Initiative (CTTI): Effective and Efficient Monitoring as a Component of Quality Assurance in the Conduct of Clinical Trials (available at https://www.ctti-clinicaltrials.org/project-topics/study-quality/effective-and-efficient-monitoring-as-a-component-of-quality)
FDA: Guidance for Industry Oversight of Clinical Investigations—A Risk-based Approach to Monitoring (available at http://www.fda.gov/downloads/Drugs/GuidanceCompliance RegulatoryInformation/Guidances/UCM269919.pdf)
European Medicine Agency: Reflection paper risk based quality management in clinical trials (available at http://www.ema.europa.eu/docs/en_GB/document_library/Scientific_guideline/2011/08/WC500110059.pdf.)
CPGM 7348.810: Sponsors, Contract Research Organizations and Monitors (available at http://www.fda.gov/ICECI/EnforcementActions/BioresearchMonitoring/ucm133777.htm)
CPGM 7348.811: Clinical Investigators and Sponsor-Investigators (available at http://www.fda.gov/ICECI/EnforcementActions/BioresearchMonitoring/ucm133562.htm.

An overarching goal of the disclosed subject matter is to enhance human subjects' protection and quality of clinical trial data using a risk-based monitoring approach which relies on a combination of monitoring strategies, including greater reliance on centralized monitoring with correspondingly less emphasis on on-site monitoring. The monitoring plan should be tailored to the needs of the trial and the protocol should clearly identify those procedures and data that are critical to subject safety and the integrity and reliability of the study findings. In addition the monitoring plan may include a schema identifying those subjects targeted for on-site review.

Accordingly, the disclosed subject matter provides improved techniques to ensure that limited resources are best targeted to address the most important issues and priorities, especially those associated with predictable or identifiable risks to the wellbeing of trial subjects and the quality of trial data.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description, as well as from the appended drawings.

The Enhanced Monitoring (EM) method disclosed herein allows clinical trial Sponsors to have better oversight of site activity earlier by ensuring Remote Review (RR) of data is performed. This method allows better Sponsor oversight by identifying any issues or trends early in the study and between onsite Sponsor monitoring visits. In addition, this method allows the Sponsor to continuously review and “clean” data as they are entered so that at critical time points in the trial, the database can be locked and available earlier for data extractions for regulatory submissions, publications & presentations.

Enhanced Monitoring (EM) is a new approach to monitoring of medical studies and procedures (e.g., clinical trials). EM includes a combination of on-site monitoring which includes Targeted Source Data Verification (TSDV) as well as Remote Review (RR). Utilization of EM allows the Clinical Research Associates (CRAs) to focus their efforts on the review of critical safety and efficacy variables and ensuring overall site management and compliance. In accordance with an aspect of the disclosure, an Enhanced Data Review Plan (EDRP) tool is provided which provides collaboration between the CRA, Clinical Data Management (CDM), and Safety groups. The EDRP lists each data point that is included in the electronic case report forms (eCRF), and then shows which group/groups (CRA, CDM, Safety) will be reviewing that particular data point.

Accordingly, the EDRP serves to decrease the overlap in data review by the three groups in order to increase efficiency and decrease costs. In accordance with another aspect of the disclosure, a suite of metric reports is provided that allow for the oversight and management of sites and studies using the EM approach.

According to an embodiment of the present disclosure, a system for monitoring a clinical trial is provided. The system includes a data input terminal. The data input terminal is located at a data collection point and includes a plurality of input validation rules. The data input terminal receives data from a user. The data has a datatype. The data input terminal applies at least one of the plurality of input validation rules to the data. The system includes a first datastore receiving data from the data input terminal. The system also includes a data analysis server. The data analysis server includes a plurality of data validation rules. The server received the data from the first datastore and applies at least one of the plurality of data validation rules to the data to obtain a result. The server includes a plurality of triggers. The server initiates at least one of the triggers based on the result of the application of the at least one of the plurality of data validation rules.

According to another embodiment of the present disclosure, a method and computer program product for monitoring of clinical data is provided. A plurality of rules is read from a rulebase. Input data is read. The input data comprises a plurality of values. The plurality of rules is applied to the input data to determine an indicator for each of the values. The indicator for each of the values indicates whether the value is erroneous. Based on the indicators for each of the values, at least one trigger is initiated.

It is to be understood that both the foregoing general description and the following detailed description are exemplary and are intended to provide further explanation of the disclosed subject matter.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIG. 1 is a system diagram of an Enhanced Monitoring system in accordance with the disclosed subject matter.

FIG. 2 is an exemplary flow chart of the Enhanced Monitoring system in accordance with the disclosed subject matter.

FIGS. 3A-3C are an exemplary Data Monitoring Guideline highlighting representative variables for remote review, onsite review and logic checks. FIG. 3A depicts header information, as well as representative variables for remote review and onsite review. FIG. 3B depicts additional representative variables for remote review. FIG. 3C depicts additional representative variables for review, as well as representative variables for logic checks.

### DETAILED DESCRIPTION OF THE PREFERRED EMBODIMENT

Reference will now be made in detail to the preferred embodiments of the disclosed subject matter, an example of which is illustrated in the accompanying drawings. The method and corresponding steps of the disclosed subject matter will be described in conjunction with the detailed description of the system.

Throughout this disclosure reference will be made to several terms, a list of definitions is provided below.

Enhanced monitoring (EM): EM includes a combination of on-site monitoring which includes Targeted Source Data Verification (TSDV) as well as Remote Review (RR). Utilization of EM allows CRAs to focus their efforts on review of critical safety and efficacy variables and ensuring overall site management and compliance.

Remote Review (RR): RR activities are performed outside the clinical research site setting. RR may include: reviewing data entries, issuing and closing queries, running reports to identify outliers and trends in protocol deviations and other types of non-compliance, as well as other site management activities. RR is conducted as dictated by site activity and trial-specific requirements. RR activities may include generating reports and listing that allow a reviewer to identify those sites that are outliers, for example with extremely high or low reported adverse events. An outlying number of reported adverse events may be indicative of underreporting or other methodological issues requiring further investigation.

Targeted Source Data Verification (TSDV): TSDV is a method by which select data points in the electronic case report form (eCRF) (i.e., critical variables) are compared to source documentation to verify accuracy and validity. Targeted Source Data Verification may be applied to a predetermined subset of sites or subjects at a site. In some embodiments, the predetermined subset is determined by the schema.

Data Monitoring Guidelines (DMG): The DMG lists each data point in the case report form. This guideline identifies the TSDV and RR strategy. It describes which data points are reviewed remotely and which data points must be reviewed during an on-site monitoring visit. In addition, the DMG includes guidance regarding data checks and other information needed to assist the CRA during on-site and remote data review and to help ensure consistency. This document is created by the Lead Field CRA and the Lead Clinical Data Manager in collaboration with the EM Committee (as needed) prior to first patient in (FPI).

Enhanced Data Review Plan (EDRP): The EDRP is an iteration of the DMG. The EDRP provides all the information available in the DMG, and in addition, includes information describing which clinical group (i.e., Safety, Clinical Data Management, CRA) will review each data point, in order to avoid overlap and redundancy during data review when possible. This document is created by the Lead Field CRA, Lead Clinical Data Manager and Lead Safety Monitor in collaboration with the EM Committee (as needed) prior to first patient in (FPI).

Critical Variable (CV): Critical variables are data that must be 100% source data verified. Examples of critical variables include: safety and efficacy variables, endpoints, eligibility criteria, informed consent information, and inventory accountability (if applicable).

Non-critical Variable: Non-critical variables are data that are not related to safety and efficacy, endpoints, eligibility criteria, etc., and, therefore, may be reviewed remotely if a review is required. In some embodiments, a subset of non-critical variables are identified as not requiring any review.

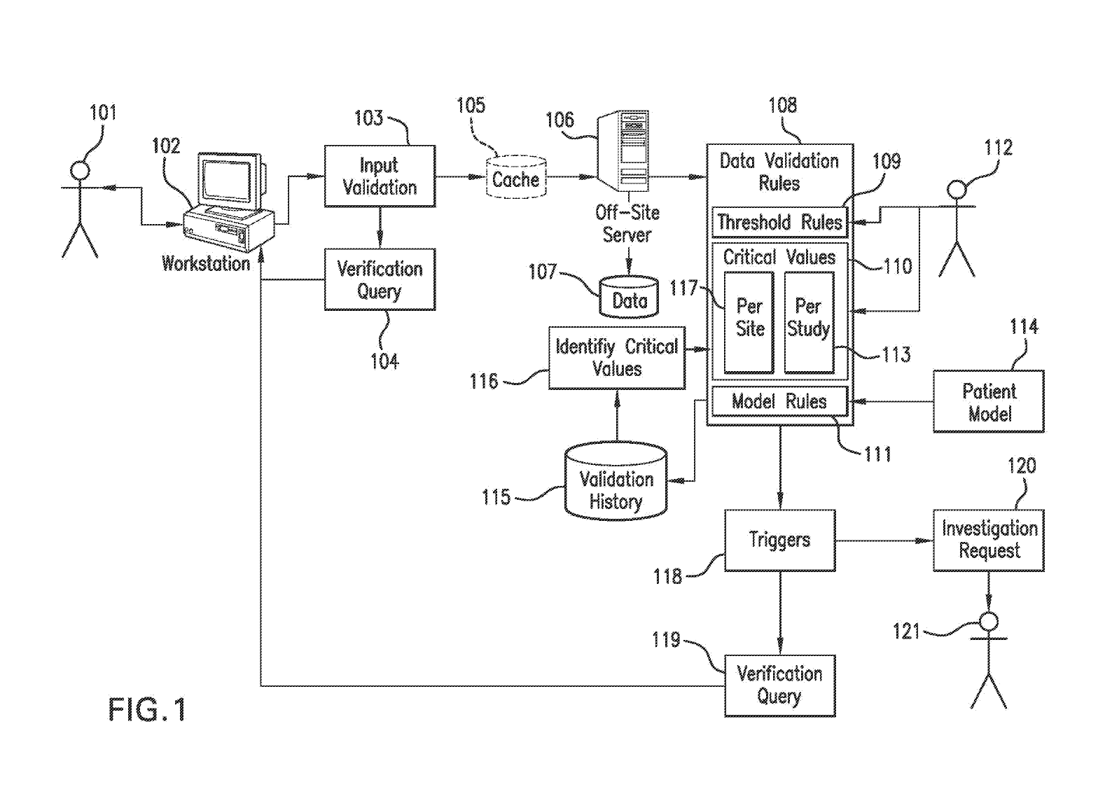

Referring now to FIG. 1, an onsite user 101 is responsible for entering data into workstation 102. Workstation 102 may be a desktop computer, laptop, tablet, mobile phone, or other computing device having a human interface device. In some embodiments, workstation 102 provides a graphical user interface for the entry of data. In some embodiments, the user interface is a web-based user interface and provides for form-based entry of data. Preliminary input validation is performed by validation module 103. In some embodiments, validation module 103 is computer executable code running on workstation 102. For example, in embodiments in which the user interface is a web-based interface, input validation module 103 may be javascript that is run by a web browser of workstation 102 to validate data as it is input by user 101. In embodiments in which the user interface of workstation 102 is a locally stored and executed application, input validation module 103 may be a program module of the application. If data entered by user 101 is found to be invalid by validation module 103, a verification query 104 is initiated. In some embodiments, the verification query is displayed on the user interface of workstation 102 for immediate action by user 101. However, in other embodiments, the verification query may be dispatched to another workstation via, for example, email or instant message.

Examples of verification queries include a request for clarification or correction of a numeric value. For example, normal blood pressure is in the range of 90-119 mmHg systolic and 60-79 mmHg diastolic. Blood pressure in the range of 120-180 mmHg systolic and 80-110 mmHg diastolic may indicate disease. Blood pressures above these ranges are likely the result of an error in measurement or data entry. Thus, if user 101 entered a numeric value of 900 mmHg, input validation module 103 would issue a verification query requesting clarification of this numeric value.

If data is determined to be valid by validation module 103, the data is dispatched for storage. In some embodiments, the data is stored in a cache 105. In the some embodiments, cache 105 is integral to workstation 102. For example, a temporary datastore may be provided by the web browser of workstation 102. In other embodiments, cache 105 is local to the site at which workstation 102 is deployed. In some embodiments the data is dispatched on a rolling basis as it is validated. In other embodiments, data entry is batched, for example into a form aggregating multiple related values, and dispatched as a batch.

After input validation 103, data is transmitted to server 106. As noted above, data may be temporarily stored in a cache 105 prior to receipt at server 106. In some embodiments, data is transmitted via the Internet to server 106. This transmission may be through various gateways, routers, subnets, VPNs and other instrumentalities known in the art. In some embodiments, server 106 may be located in the same Local Area Network (LAN) as workstation 102. Server 106 may be a virtual server or cloud server. Server 106 includes datastore 107. Datastore 107 may be a relational database, a non-relational datastore, or a file-based datastore known in the art. Examples of suitable datastores include MySQL, MariaDB, PostgreSQL, SQLite, Microsoft SQL Server, Oracle, SAP, dBASE, FoxPro, IBM DB2, LibreOffice Base, FileMaker Pro, Google's BigTable, Amazon's Dynamo, Windows Azure Storage, Apache Cassandra, HBase, Riak, Voldemort, and HDFS. In some embodiments, datastore 107 is located on server 106. In other embodiments, datastore 107 is accessible to server 106 via a network.

In some embodiments, data validation module 108 resides on server 106. In other embodiments, data validation module 108 resides on another server, for instance a cloud server. Data validation module 108 reads data from datastore 107 either directly, or via server 106. Data validation module 108 includes a plurality of rules. Rules include threshold rules 109, critical values 110, and model rules 111. Data validation module 108 applies each its rules to the data from datastore 107. In general, rules are run against new data only once, however, in some embodiments new rules are run against existing data.

Threshold rules 109 may be entered by user 112, who in some embodiments is the Lead Clinical Data Manager. Threshold rules provide ranges in which a value is considered likely accurate, and ranges in which a value is considered likely inaccurate. To revisit the blood pressure example from above, while a numeric value of 900 mmHg is clearly erroneous, a value of 175 mmHg for systolic pressure is high enough to be suspicious, but is not clearly erroneous. Threshold rules may vary depending on the particular study. For example, in a study involving generally healthy subjects, a value of 175 mmHg will be more likely erroneous than in a study targeting those undergoing treatment for hypertension. In some embodiments, individual threshold rules are applied to individual measurements. In some embodiments, threshold rules are applied to a collection of measurements. For example, a threshold rule may be applied to systolic and diastolic pressure together, indicating a suspicious measurement where systolic pressure is lower than the healthy range while diastolic pressure is higher than the healthy range. For another example, the lower boundary of normal blood pressure may be determined by age, i.e., 75/50 mmHg for subject less than one year old. In other embodiments, a function may be applied to multiple values to determine whether a value is suspect. For example, the ratio of CSF glucose to blood glucose is approximately 0.6 in a healthy subject. Where data comprises CSF glucose and blood glucose, a threshold rule may be applied to both values to determine whether the ratio lies within a predetermined percentage of 0.6.

In some embodiments, threshold rules are Boolean functions. In such embodiments, they output true where a value, series of values, or numeric function of values falls within a predetermined closed or open range. In some embodiments, threshold rules are probability functions. In such embodiments, they output a probability indicating the likelihood that an input value, series of values, or numeric function of values is erroneous. An exemplary probability distribution is provided below in Table 1 for systolic blood pressure. In this example, the probability is 1.0 for clearly erroneous values, and close to 0.0 for likely accurate values.

TABLE 1

| Systolic pressure (mmHg) | Probability of Error |
|---|---|
| <0 | 1.0 |
| 0-74 | 0.9 |
| 75-89 | 0.5 |
| 90-119 | 0.1 |
| 120-139 | 0.1 |
| 140-159 | 0.3 |
| 160-179 | 0.3 |
| 180-200 | 0.9 |
| >200 | 1.0 |

Data validation module 108 may also include critical variables 110. As discussed above, critical variables are those which must be 100% source data verified. Critical variables vary from study to study, and may include safety and efficacy variables, endpoints, eligibility criteria, informed consent information, and inventory accountability. Per study critical variables 113 may be entered by user 112, preloaded, or transmitted from a remote repository.

Per study critical variables may designate those values that inherently require further action based on the individual study. Per study critical variables may also designate those values for which an alternative threshold value is applicable. For example, in a study of diabetes management, blood glucose may always require on-site verification. Alternatively, the acceptable range of values may be narrower, requiring verification in more cases than in another study.

In some embodiments, model rules 111 may also be included in validation module 108. Model rules 111 are generated by patient model 114. Patient model 114 provides a simulation of a subject. In some embodiments, patient model 114 is generally applicable, while in some embodiment, patient model provides a subject-specific simulation based on an individual subject's characteristics. In one embodiment, patient model 112 simulates changes over time of physical characteristics based on a physiological model and based on prior data. For example, blood pressure varies on 24 hour cycle, and so expected observed values will vary based on the time that a measurement is made. Whether or not a given observation requires further investigation thus in part depends upon time of day, which is accounted for by patient model 114. In some embodiments, patient model 114 accounts for complex correlation among observed values. For example, a given drug may elicit a characteristic response in a subject which should be reflected in the observed data. If the data does not reflect such a response, then although a given value may be within a normal range it may require further investigation. In this way, patient model 114 assists in identifying non-compliance with treatment guidelines even where individual data points do not appear abnormal.

In some embodiments, patient model 114 is modular and is tailored to a particular population of interest. For example, a given age group is likely to have different characteristics than another age group. Thus, patient model 114 will vary between studies targeting two disparate age groups. By virtue of modularization, patient model 114 may be substituted for another suitable module according to the requirements of a given study.

As rules are run against data from individual sites, a history 115 is built for each site. History 115 is persisted in a database or other suitable data storage such as a log file. As data collected from a given site for a given value fails validation, patterns emerge as to those values for which a given site is particularly unreliable. Based on history 115, the critical values for each individual site are identified by identification module 116. In some embodiments, identification module 116 flags a value as critical for a given site where there are more than a predetermined number of validation failures. In some embodiments, identification module 116 flags a value as critical for a given site where the validation failures are outside of a certain range of a normal value. For example, a value may be flagged as critical for a given site when any value is entered that is more than 2 standard deviations from the mean of that value. A combination of criteria may be applied to flag a value as critical, for example a predetermined number of values outside of 2 standard deviations of the mean might be indicative of a critical value.

The results from data validation module 108 may activate various triggers 118. Activation of triggers may be based on the number of values failing validation by data validation module 108, based an aggregate probability data is erroneous, or based on a function of the outputs of the data validation rules. As an example, where a given value fails validation because it lies outside a range, a verification query 119 is fired. Verification query 119 is transmitted back to on-site workstation 102 via a network (not pictured). Verification query 119, like verification query 104 may be displayed immediately on a display of workstation 102, or may be transmitted to a third party via email, instant message, or other digital communications. In another example, an investigation request 120 is fired. An investigation request 120 is directed to an investigator 121. Investigator 121 examines the data that led to a validation failure and makes a determination as to whether on-site intervention is required. In various embodiments, different messaging or alerting may be triggered, including automated phone call, text message or email. Messages include information describing the validation failure and the suspect data. In some embodiments, the particular event triggered is determined by the particular pattern of validation failures. For example, an unusual blood pressure reading may trigger an email to the collection site, while an unusual blood glucose reading may trigger an investigation request for an on-site visit. In some embodiments investigator 121 is a Clinical Research Associate (CRA), and investigation request 120 is for a monitoring visit or investigational site visit. In some embodiments, investigator 121 is a sponsor.

The rules described herein may be combined in a rulebase. In some embodiments, the rules and triggers are combined together in the rulebase. In some embodiments, the rulebase is optimized or compiled prior to application to incoming data. In some embodiments, a Rete algorithm is used for applying the rules in the rulebase and activating the triggers. However, other rule engines known in the art may be used according to the present disclosure.

In some embodiments, progressive warnings may be triggered as a result of validation rules. For example, a trend in data may be identified by firings of threshold rules against successive data sets. In an embodiment in which a threshold rule provides a probability function, an increase over time of the probability of error in a value may be extrapolated forward to provide a predicative warning. This warning may be in the form of an investigation request or verification query as described above, or may be a predictive report identifying the trend of concern. The report may be transmitted, for example, via email. In this way, investigation may be triggered of a site that is about to leave the normal operating range, for example by having more than a predetermined number of data errors.

In combination, the storage of validation history 115 and identification of new critical values 116 enables the validation module 108 to learn the particular attributes of individual sites. In addition, validation history 115 allows comprehensive evaluation of sites after the conclusion of a given study. This information is useful for determining whether or not a given site should be used in future studies.

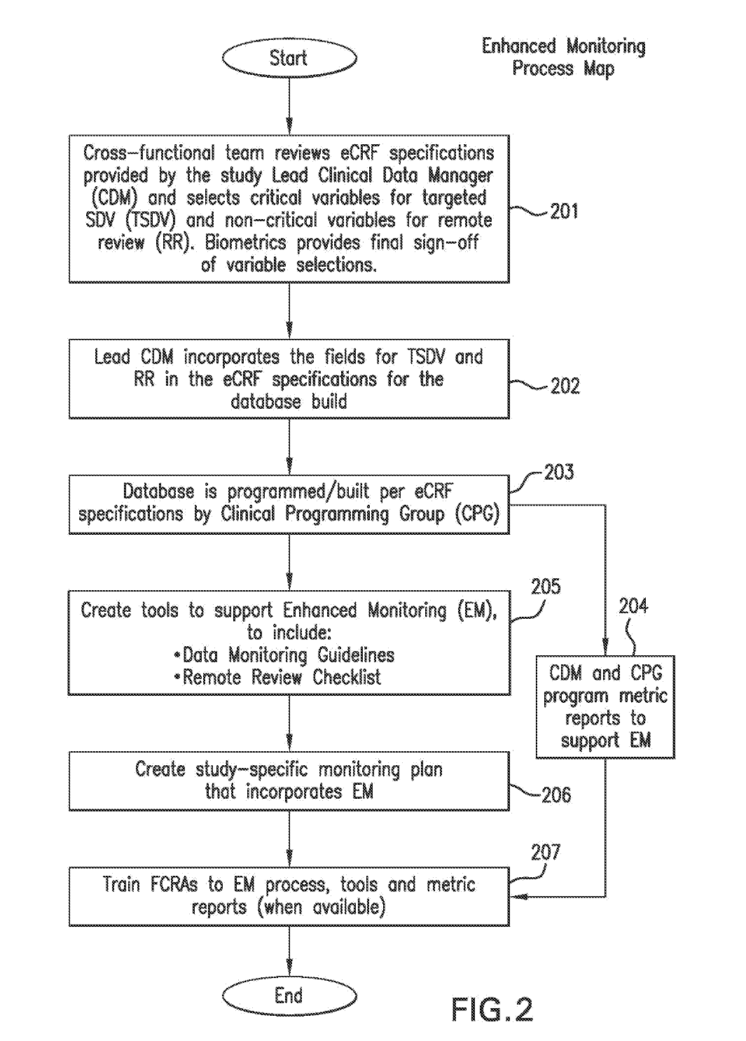

Referring to FIG. 2, an exemplary enhanced monitoring process map is provided according to an embodiment of the present disclosure. At 201, a cross-functional team reviews eCRF specifications provided by the study Lead Clinical Data Manager and selects critical variables for Targeted SDV (TSDV) and non-critical variables for remote review (RR). In some embodiments, Biostatistics provides final sign-off of variable selections. At 202, the Lead CDM incorporates the fields for TSDV and RR in the eCRF specifications for a database build. At 203, the database is built per the eCRF specifications by the Clinical Programming Group (CPG). At 204, CDM and CPG program metric reports to support EM. At 205, tools are created to support EM, including Data Monitoring Guidelines, Enhanced Data Review Plan, and a Remote Review Checklist. At 206, a study specific monitoring plan is created that incorporates EM. At 207, CRAs are trained to EM process, tools, and metric reports (where available).

An initial step in the EM process disclosed herein is selection of Critical and Non-critical variables. In one embodiment, the Lead Field Clinical Research Associate (FCRA) and Lead Clinical Data Manager (CDM) are responsible for establishing a cross function team to review all data points and determine which data points are critical and which are non-critical. In addition to the Lead Field CRA and Lead Clinical Data Manager, at a minimum, the cross functional team will be comprised of one representative from each of the following areas: Project Management; biostatistics; Clinical Safety; Clinical Science; Clinical Field Operations Management; and Enhanced Monitoring Committee.

Critical variable selection may be performed in parallel as the eCRF specifications are being reviewed during meetings coordinated by CDM with the cross-functional team. These team members meet and review each data point in the eCRF to determine whether each will be designated as critical or non-critical. The critical variables will be 100% source data verified. Examples of critical variables include but are not limited to: Adverse events/adverse device effects; Endpoints (primary and secondary); Reasons for study termination; Stratification variables; Informed consent forms (ICFs); Eligibility criteria; Product experiences/device deficiencies or malfunctions; and Device inventory information.

Non-critical data points not otherwise excluded may be reviewed remotely unless a change in the site monitoring strategy is necessary due to non-compliance issues. Examples of non-critical variables include: Visit dates; Medical history Demographics; Patient diaries/questionnaires; Concomitant medications; and Lab values not related to endpoints.

In an exemplary embodiment of the EM system disclosed herein, the biostatistics group reviews and has final sign-off on the critical variable selections from the cross-functional team. Once the critical and non-critical data points for the trial are established, the Data Monitoring Guideline (DMG) or Enhanced Data Review Plan (EDRP) will be created by the Lead Field CRA, Lead CDM, and Lead Safety Monitor in collaboration with the other team members. The final DMG/EDRP will be distributed to all team members and will be reviewed during the CRA training. The Lead Field CRA is responsible for any updates/revisions to the document as well as any training that might be required. A history of DMG/EDRP updates will be tracked and included within the DMG/EDRP. The DMG/EDRP is for internal use only and will not be distributed to clinical sites. In addition, the clinical sites will not be provided with information about which data point will be reviewed on-site versus remotely (or not reviewed at all).

In order to achieve and maintain the level of efficiency gained by using the EM model, it is necessary for each trial to adhere to the following guidelines in terms of critical variable selection:

TABLE 2

| Type of Trial | Overall Percentage of Critical Variables |
|---|---|
| IDE/CE Mark | 20-40% |
| Post Approval | 10-20% |

The EM model disclosed herein provides a variety of tools. Examples of such tools include: Protocol; Training slides; Monitoring Plan; Data; Monitoring Guideline (DMG); Enhanced Data Review Plan (EDRP); Remote Review Checklist; EDC question help text; EDC metric reports; IVRS reports; Core Lab reports; Monitoring visit reports & completion guidelines; and Electronic Trial Management Systems (e.g., CTMS; CDC/Webtop; CDRT; and ClinDev). The particular tools employed in a given application/embodiment of the EM model disclosed herein will vary depending on the particular trial requirements. The availability and functionality of such tools is outlined during the RCA training.

In accordance with another aspect of the disclosed subject matter, metric reports are generated from the Electronic Data Capture (EDC) system. These reports will be utilized by various team members to monitor query metrics (types of queries, query aging, etc.) and compliance (e.g., data entry timelines; remote review frequency), and to identify any outlyers that require further investigation.

In accordance with another aspect of the disclosed subject matter, training of EM and the appropriate EM tools will typically be done during the clinical trial start-up training session. Follow-up training sessions will be performed as necessary (e.g., protocol amendments requiring eCRF revisions, revised EM tools, etc.). These trainings generally are provided by the Lead Field CRA with support from the Lead Clinical Data Manager and the EM Committee if needed.

The goal of the EM model is to increase efficiency and decrease costs while maintaining quality and compliance at clinical sites. If serious quality and/or compliance issue(s) are noted at any point during RR or on-site visits, the issue(s) will be escalated to the Lead FCRA and Lead Field Manager. The Lead Field Manager, Lead FCRA and Project Manager (and other Clinical Study Team members as necessary) will evaluate the issue(s) and determine a plan to address them. The issue(s) will be documented and may result in a variety of measures to increase quality and compliance, including, but not limited to: increased % source data verification for the site, and increased on-site visit frequency. Once the CRA, Lead Field CRA, Lead Field Manager, and Project Manager feel that the issues have been adequately addressed, the site may return to the original monitoring frequency and/or % SDV. Any adjustments in visit frequency or change in % SDV will be documented in the DMG/EDRP or within the EDC's TSDV module (when available).

The EM model disclosed herein is a three-part integrated approach, wherein each part is mutually dependent on the other. The three parts can be classified as:

1) Increased on-site monitoring intervals

2) Remote Review

3) Targeted Source Data Verification.

The increased on-site intervals serve to extend the average interval across the entire study. Additionally, it provides flexibility to adapt to a particular site's needs. For example, it is possible to request a shorter monitoring interval due to: i) high enrollment or high activity; ii) quality or compliance issues; or iii) data required for an upcoming Interim Analysis per protocol. Alternatively, it is possible to request a longer monitoring interval due to: i) low enrollment or no/low activity; or ii) no quality or compliance issues.

The Remote Review is the cornerstone of the EM approach disclosed herein. The Remote Review allows for the real-time identification of: status of data entry; logic of related data issues; errors; omissions; query resolutions trends of non-compliance and issues requiring attention. This is advantageous in that it avoids retroactive work, compliance issues, and inefficient site visits.

The Remote Review tools include: Protocol Monitoring Plan; Data Monitoring Guidelines (DMG); Enhanced Data Review Plan (EDRP); Remote Review Checklist; eCRF question help text; IVRS Reports; EDC Metrics Reports; EDC Standard Reports; Core Lab Reports; Trial Specific Tools (if applicable); Monitoring Visit Reports; CTMS; CDC; ClinDev; and Training Slides.

Performing remote data reviews include checks for: i) Logic (one's reasoned and reasonable judgment of the study data); ii) compliance: involves looking across systems to ensure that the subject is following the protocol, e.g., completing follow-up visit assessments; and iii) conventions: with each trial there are conventions or trial-specific information that needs to be followed, e.g., protocol, EDC completion guidelines.

Targeted Source Data Verification (TSDV) is defined as an on-site data examination that focuses on the critical safety and efficacy issues of a study. TSDV differs from 100% SDV because verification of every data point is not required. Time and resources are focused on targeted data points. In operation, the targeted data points are selected as follows: once the protocol is final, cross-functional study teams meet to perform a risk assessment of each data point and designate each as critical (SDV) or non-critical (RR). Clinical Data Management incorporates these assignments into the eCRF specifications.

In general, the safety and efficacy data that must be 100% SDV are: Informed Consent Form (ICF); Eligibility Criteria; End Points (Primary and Secondary); Adverse Events; Product experiences, deficiencies or malfunctions; Screen Failures; Reasons for Termination; Stratification Variables; and Verification of Discrepancies found during Remote Review.

Additionally, reading through source documents available at the site (i.e., medical chart, catheterization (cath.) lab reports, labs, etc.) is required to verify: Informed consent process and documentation is appropriate and adequate; Inclusion and exclusion criteria for eligibility; Protocol compliance; PI involvement; ICH/GCP compliance; and appropriate source documentation.

Site Management (Non-SDV) Activities include: Regulatory documentation complete, current and organized; Device accountability (if applicable); Subject screening and selection process; Ensure training of site staff; Ensure reporting of SAEs, PDs and follow-up information; Timely escalation of unresolved issues; Implementation of Corrective Action Plan (CAP); Investigate suspected misconduct (when warranted); and Ensuring adequate study supplies.

The Enhanced Monitoring (EM) model disclosed herein allows focus to be more on process than individual data points. Further, the EM model provides a myriad of benefits to the Clinical Research Associate (CRA), Site, Study itself, as well as the Sponsor hosting the study. Examples of such benefits are provided in Tables 2-3 below.

TABLE 3
Benefits of Enhanced Monitoring - CRA and Site

| Benefits to CRA | Benefits to Site |
|---|---|
| Less distractions and more time for trending to | Decreased on-site visits and less time required |
| assess “Big Picture” | for on-site query resolution allows more time |
| | for other activities |
| Decrease in travel due to increased intervals of | Sponsor provides more focused, personalized |
| on-site visits | training and support |
| By targeting specific data, the CRA can be | Frequent remote contact to address issues and |
| better prepared for the on-site visit | questions in a timely manner |
| More time for increased interactions with site | “Problems” are identified early to avoid |
| personnel and site management | repetition and larger compliance issues |

TABLE 4
Benefits of Enhanced Monitoring - Study and Sponsor

| Benefits to Study | Benefits to Sponsor |
|---|---|
| Remain compliant with ICH GCP monitoring | Increase overall cost |
| requirements | savings |
| Identify errors early to improve overall | Increase efficiencies |
| compliance, prevent “show-stoppers” and | and productivity |
| maintain/improve data quality | |
| Ensure EDC remains current and clean data is | Increase satisfaction of |
| available for timely deliverables such as annual | Sponsor personnel and |
| reports, database lock, etc. | site personnel |
| Real-time review of safety data | |

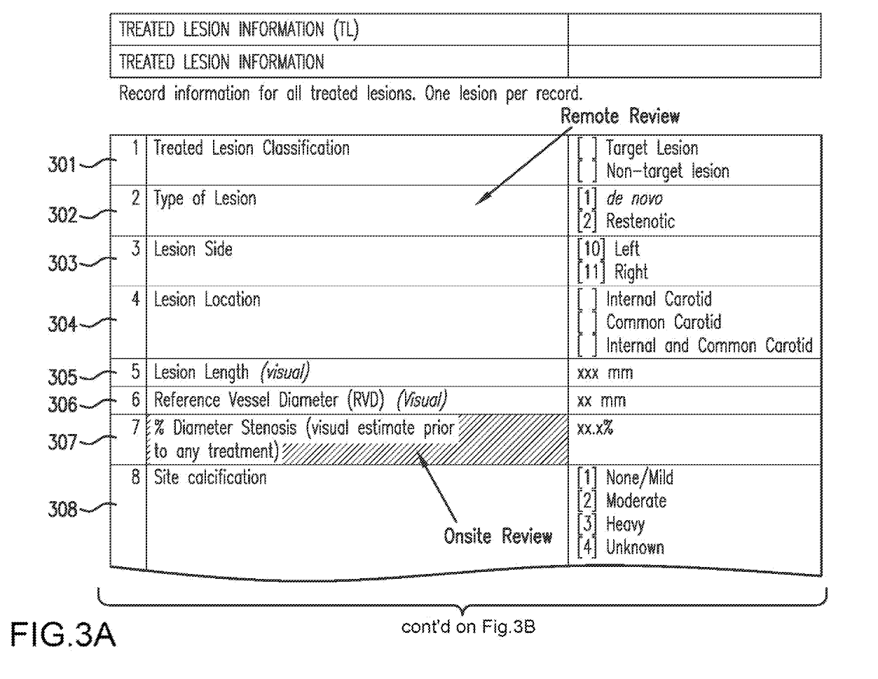

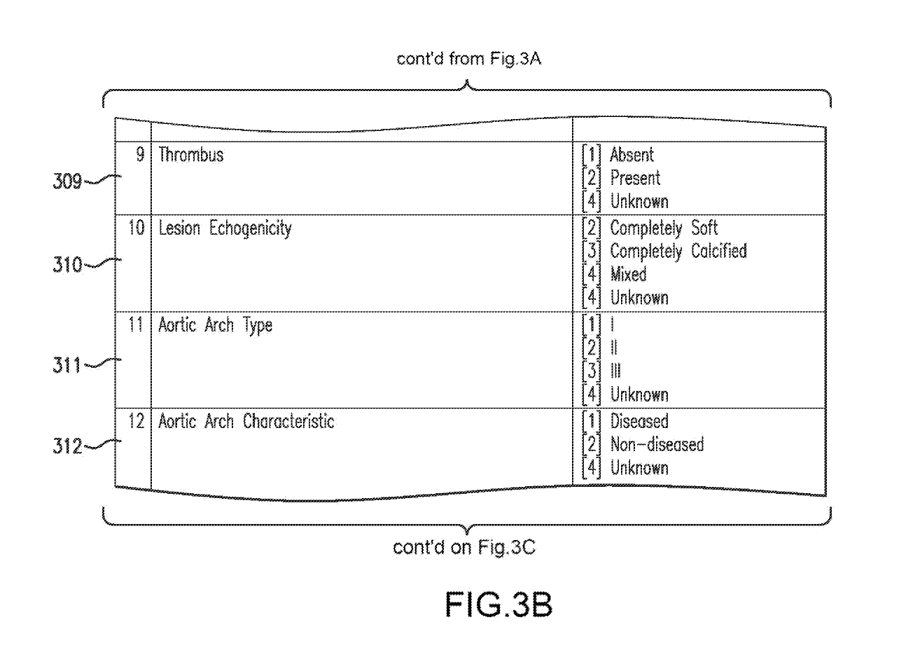

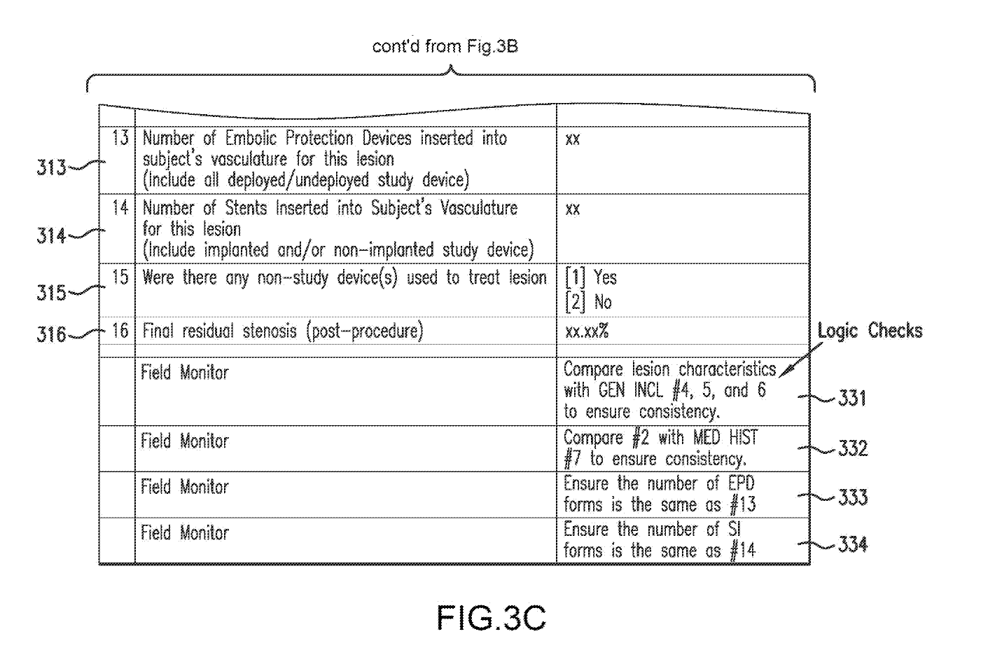

Referring to FIG. 3, an exemplary Data Monitoring Guideline (DMG) is provided. In this exemplary DMG, a plurality of values 301 . . . 316 are provided. Each value is designated for remote review, except for value 307, which is designated for onsite review. A plurality of logic checks 331-334 are provided. In some embodiments, such as discussed above with regard to FIG. 1, each of the logic checks is embodied in one or more rules.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments described herein, the disclosed subject matter is also directed to other embodiments having any other possible combination of the dependent features claimed below and those disclosed above. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the disclosure itself, and any equivalents thereof.

What is claimed is:

1. A system for monitoring a clinical trial, comprising:
a data input terminal, the data input terminal located at a data collection point and comprising a plurality of input validation rules, the data input terminal receiving data from a user, the data having a datatype, and applying at least one of the plurality of input validation rules to the data;
a first datastore receiving data from the data input terminal;
a data analysis server comprising:
a plurality of data validation rules, the server receiving the data from the first datastore and applying at least one of the plurality of data validation rules to the data to obtain a result;
a plurality of triggers, the server initiating at least one of the triggers based on the result of the application of the at least one of the plurality of data validation rules.

2. The system of claim 1, wherein:
initiating at least one of the triggers comprises dispatching a verification query to the data input terminal at the data collection point, the verification query comprising a request for a data verification activity.

3. The system of claim 1, wherein:
initiating at least one of the triggers comprises dispatching an investigation request to an investigator.

4. The system of claim 1, wherein:
the result of the application of the at least one of the plurality of data validation rules is stored in a second datastore and wherein the data analysis server further comprises at least one critical type identification rule, the server receiving the result from the second datastore and applying the at least one critical type identification rule to determine a critical type.

5. The system of claim 1, wherein the plurality of data validation rules comprises a threshold rule, the server applying the threshold rule to determine whether the data falls within a numeric range of the threshold rule.

6. The system of claim 1, wherein:
the plurality of data validation rules comprises a critical type rule, the server applying the critical type rule to determining whether the datatype of the data is equivalent to a critical type of the critical type rule.

7. The system of claim 1, further comprising:
a patient model, wherein the plurality of data validation rules comprises a model rule, the patient model generating the model rule, and the server applying the model rule to determine whether the data is consistent with the patient model.

8. A method of validating clinical data comprising:
reading a plurality of rules from a rulebase;
reading input data, the input data comprising a plurality of values;
applying the plurality of rules to the input data to determine an indicator for each of the values, the indicator for each of the values indicating whether the value is erroneous;
based on the indicators for each of the values, initiating at least one trigger.

9. The method of claim 8, wherein:
the indicator is a Boolean.

10. The method of claim 8, wherein:
the indicator is a probability.

11. The method of claim 8, wherein:
initiating at least one trigger comprises dispatching a verification query to the data input terminal at the data collection point, the verification query comprising a request for a data verification activity

12. The method of claim 8, wherein:
initiating at least one trigger comprises dispatching an investigation request to an investigator.

13. The method of claim 8, wherein:
initiating at least one trigger comprises aggregating the indicators for each of the values.

14. The method of claim 8, further comprising:
storing in a datastore the indicators for each of the values;
determining from the indicators in the datastore a critical value;
creating a new rule such that when applied, the rule indicates that the critical value is likely erroneous;
storing the new rule in the datastore.

15. The method of claim 8, further comprising:
applying a patient model to determine a model rule, the patient model relating at least two clinical values by at least one constraint;
applying the model rule to the input data to determine whether the at least two clinical values in the input data meet the at least one constraint.

16. The method of claim 8, wherein:
applying the plurality of rules to the input data comprises applying a rule engine.

17. A computer program product for monitoring of clinical data, the computer program product comprising a computer readable storage medium having program code embodied therewith, the program code executable by a processor to:
read a plurality of rules from a rulebase;
read input data, the input data comprising a plurality of values;
apply the plurality of rules to the input data to determine an indicator for each of the values, the indicator for each of the values indicating whether the value is erroneous;
based on the indicators for each of the values, initiate at least one trigger.
